(19) United States
(12) Patent Application Publication
(10) Pub. No.: US 2015/0052620 A1
(43) Pub. Date: Feb. 19, 2015

(54) MANAGEMENT OF USER RIGHTS TO MEDIA CONTENT

(71) Applicant: KT Corporation, Seongnam-si (KR)

(72) Inventor: Donghoon YI, Gapyeong-gun (KR)

(21) Appl. No.: 14/452,044

(22) Filed: Aug. 5, 2014

(30) Foreign Application Priority Data
Aug. 14, 2013 (KR) 10-2013-0096751

(51) Int. Cl. G06F 21/10

(52) U.S. Cl. CPC G06F 21/10; G06F 2221/07
USPC 726/28

(57) ABSTRACT

In one example embodiment, a server includes a receiver configured to receive, from a first device, a request to issue user rights to media content; a user rights divider configured to divide full user rights to the media content into a plurality of user sub-rights to the media content; and a user rights manager configured to issue one or more of the plurality of user sub-rights to the media content to a user account authenticated on the first device.

### TECHNICAL FIELD

The embodiments described herein pertain generally to a management of user rights to media content.

### BACKGROUND

With development and popularization of computer and smartphone technologies, copyrighted materials such video content, audio content or eBook content that have been previously managed and transacted in analog form are now digitized. Known approaches for protecting digital content with DRM (Digital Rights Management) may prevent unauthorized redistribution of such content and may restrict unauthorized reproduction and redistribution of purchased content. Thus, the transmission of the digital content may include issuance of authorized user rights or licenses to the digital content.

### SUMMARY

In one example embodiment, a server may include a receiver configured to receive, from a first device, a request to issue user rights to media content; a user rights divider configured to divide full user rights to the media content into a plurality of user sub-rights to the media content; and a user rights manager configured to issue one or more of the plurality of user sub-rights to the media content to a user account authenticated on the first device.

In another example embodiment, a system may include a device configured to transmit a request to issue user rights to media content; and a server configured to: divide full user rights to the media content into a plurality of user sub-rights to the media content, and issue one or more of the plurality of user sub-rights to the media content to a user account authenticated on the device.

In yet another example embodiment, a method performed under control of a server may include receiving, from a device, a request to issue user rights to media content; dividing full user rights to the media content into a plurality of user sub-rights to the media content; and issuing one or more of the plurality of user sub-rights to the media content to a user account authenticated on the device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent from the following detailed description. The use of the same reference numbers in different figures indicates similar or identical items.

FIG. 1 shows an example system in which management of user rights to media content may be implemented, in accordance with various embodiments described herein;

FIG. 2 shows an illustrative example device by which at least portions of management of user rights to media content may be implemented, in accordance with various embodiments described herein;

FIG. 3 shows another illustrative example device by which at least portions of management of user rights to media content may be implemented, in accordance with various embodiments described herein;

FIG. 4 shows another illustrative example device by which at least portions of management of user rights to media content may be implemented, in accordance with various embodiments described herein;

FIG. 5 shows an example server by which at least portions of management of user rights to media content may be implemented, in accordance with various embodiments described herein;

FIG. 6 shows an example processing flow of operations by which at least portions of management of user rights to media content may be implemented, in accordance with various embodiments described herein;

FIG. 7 shows another example processing flow of operations by which at least portions of management of user rights to media content may be implemented, in accordance with various embodiments described herein; and

FIG. 8 shows an illustrative computing embodiment, in which any of the processes and sub-processes of management of user rights to media content may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

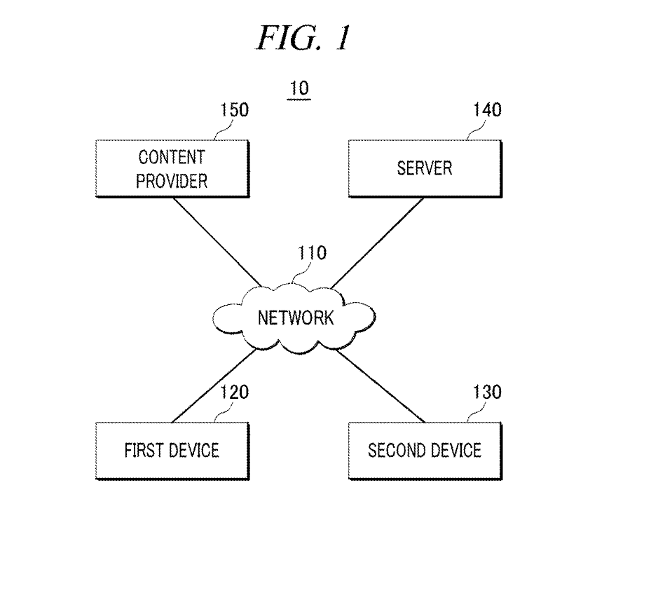

FIG. 1 shows an example system 10 in which management of user rights to media content may be implemented, in accordance with various embodiments described herein. As depicted in FIG. 1, system configuration 10 may include, at least, a network 110, a first device 120, a second device 130, a server 140 and a content provider 150. At least two or more embodiments of first device 120, second device 130, server 140, and content provider 150, respectively, may be communicatively connected to each other via network 110.

Network 110 may include, as non-limiting examples, a wireless network such as a mobile radio communication network including at least one of a 3rd generation (3G), 4^{th} generation (4G), or 5^{th} generation (5G) mobile telecommunications network, various other mobile telecommunications networks, a satellite network, WiBro (Wireless Broadband Internet), Mobile WiMAX (World Interoperability for Microwave Access), HSDPA (High Speed Downlink Packet Access), or the like.

As non-limiting examples, respective ones of first device 120 and second device 130 may refer to a notebook computer, a personal computer, a smart phone, a digital camera, a tablet computer, a phablet device, a smart television, a set-top box and a display coupled thereto, or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro terminal.

Server 140 may refer to one or more apparatuses or servers hosted and/or supported by a service providing organization or entity that may issue user rights to media content to a user account authenticated on respective ones of first device 120 and second device 130. Server 140 may further manage transactions of the user rights to the media content between the user accounts authenticated respectively on first device 120 and second device 130.

Content provider 150 may refer to a server, a computing device or a processing apparatus hosted and/or supported by an organization or entity, which may generate the media content, and that may transmit the media content to first device 120 and second device 130.

First device 120 may be configured to receive media content from content provider 150. In some embodiments, a user of first device 120 may want to request or order the media content. Thus, first device 120 may transmit, to content provider 150, the request or the order for the media content, and the requested or ordered media content may be provided to first device 120. Non-limiting examples of the media content may refer to at least one of eBooks, video files, audio files, e-coupons or e-gift cards. In some embodiments, the media content received from content provider 150 may be encrypted content that has been encrypted by content provider 150 with an encryption key.

First device 120 may be further configured to transmit, to server 140, a request to issue user rights to the media content. The user rights are needed for first device 120 to legally play or reproduce the received media content thereon, and thus a user of first device 120 may request or order for the user rights to the media content. Further, server 140 may be configured to receive, from first device 120, the request to issue the user rights. For example, but not as a limitation, user rights to the media content may refer to full or limited authorization to access, use, play, reproduce, listen, read and/or download the media content from content provider 150.

Server 140 may be configured to manage user rights to the media content. Server 140 may authenticate first device 120, based on authentication information of first device 120 from which the request for user rights was received. For example, but not as a limitation, the authentication information of first device 120 may include a unique identifier of first device 120, a serial number, or a phone number assigned to first device 120.

Server 140 may transmit, to first device 120, multiple terms and/or conditions under which server 140 may divide full user rights to the media content into multiple user sub-rights. Server 140 may receive, from first device 120, a user selection from among the multiple terms for the division of user rights, and may determine the number of user sub-rights into which the full user rights may be divided based on the user selection. In some embodiments, server 140 may transmit the multiple terms to first device 120, when server 140 receives the request to issue the user rights from first device 120. The full user rights to the media content may include at least one of a full allocation of plays of the media content or a full allocated period of time in which to play the media content. The full allocation of plays of the media content or the full allocated period of time in which to play the media content may be determined and/or set by content provider 150 or a user of first device 120. Each of the multiple terms and/or conditions for the division of user rights may refer to terms and/or conditions under which server 140 may divide the full user rights, which may include a full allocation of plays of the media content or full allocated period of time in which to play the media content, into multiple user sub-rights that may include multiple various sub allocations of plays of the media content or multiple various sub allocated periods of time in which to play the media content.

Further, server 140 may receive, from first device 120, one or more of the multiple terms and/or conditions for user rights division. Further, the term may include a number of multiple user sub-rights into which the full user rights to be divided, and sub allocations of plays of the media content or sub allocated periods of plays of the media content, which is associated with each user sub-rights.

Server 140 may then divide the full user rights to the media content into the multiple user sub-rights to the media content, based on the received one or more terms. For example, but not as a limitation, server 140 may divide the full user rights that allow the media content to be played up to, e.g., total 100 times into four user sub-rights, each of which has sub allocations that allow the media content to be played up to, e.g., 25 times. The full allocation of plays (e.g., 100 times) of the media content may be determined by server 140.

Further, server 140 may issue, to a user account authenticated on first device 120, one or more user sub-rights to the media content from among the multiple user sub-rights. Further, in some embodiments, server 140 may transmit, to first device 120, a decryption key that may be used to decrypt the encrypted media content, along with the one or more user sub-rights to the media content.

In some embodiments, server 140 may issue, to the user account authenticated on first device 120, first user sub-rights to the media content from among the multiple user sub-rights.

For example, server 140 may issue first user sub-rights to play the media content 25 times from among the four user sub-rights. First device 120 may then receive and store the issued one or more user sub-rights to the media content in a memory. Further, first device 120 may play or reproduce the media content up to 25 times, based on the issued first user sub-rights.

Server 140 may be further configured to revoke the issued user sub-rights to the media content from the multiple user sub-rights when server 140 issued, to first device 120, the one or more user sub-rights to the media content. Thus, server 140 may manage the remaining user sub-rights. In some embodiments, server 140 may revoke the issued first user sub-rights to the media content from the multiple user sub-rights. Server 140 may store, in a local memory, information regarding the remaining user sub-rights from which the issued user sub-rights to the media content are removed. For example, the information regarding the remaining user sub-rights may include a number of the remaining user sub-rights, remaining authorized times or periods of plays of the media content.

Further, server 140 may be configured to issue, to the user account authenticated on first device 120, additional user sub-rights to the media content from among the multiple user sub-rights, when previously issued user sub-rights expires. For example, server 140 may issue, to the user account authenticated on first device 120, second user sub-rights to play the media content, e.g., 25 times from among the remaining three user sub-rights that are stored in the memory of server 140, if the first user sub-rights expire.

In some embodiments, server 140 may receive, from first device 120, a request to renew user rights to the media content, when the first user sub-rights expire. Server 140 may transmit, to first device 120, a user rights list that shows the remaining user sub-rights from which the first user sub-rights are removed in response to the request for renewal of the user rights. First device 120 may receive the user rights list, and display the user rights list on a display that may be part of, or communicatively coupled to, first device 120. Further, first device 120 may receive a user input to select second user sub-rights from the user rights list; and transmit, to server 140, the user input. Server 140 may receive, from first device 120, the user input to select the second user sub-rights. Further, server 140 may issue, to the user account authenticated on first device 120, the second user sub-rights, based on the received user input.

In some embodiments, server 140 may be configured to issue respective user sub-rights to different user accounts of devices for playing the media content on two or more devices based on the issued respective user sub-rights. For example, server 140 may issue, to the user account authenticated on first device 120, first user sub-rights to the media content from among the multiple user sub-rights. Further, server 140 may issue, to a user account authenticated on second device 130, second user sub-rights to the media content from among the multiple user sub-rights. For example, second device 130 may be a device that is controlled or owned by the same user of first device 120 and to which a unique identifier, a serial number or a phone number that is different from that of first device 120 is assigned. Thus, the same media content may be played on multiple devices (i.e., first device 120 and second device 130), based on respective user sub-rights to the media content.

Further, server 140 may be configured to store a user rights history regarding the issued first user sub-rights, the issued second user sub-rights, and the remaining user sub-rights, from which the first user sub-rights and the second user sub-rights are removed, in association with the user account authenticated on first device 120 and the user account authenticated on second device 130. That is, server 140 may store information that indicates that the first user sub-rights were issued to the user account authenticated on first device 120 and that the second user sub-rights were issued to the user account authenticated on second device 130 and the remaining user sub-rights are not yet transmitted.

In some embodiments, server 140 may issue, to the user account authenticated on first device 120, first user sub-rights to the media content from among the multiple user sub-rights. Further, server 140 may receive, from first device 120, a request to sell second user sub-rights to the media content from among the multiple user sub-rights to the user account authenticated on second device 130. Server 140 may further issue, to the user account authenticated on second device 130, the second user sub-rights to the media content from among the multiple user sub-rights, based on the received request. For example, second device 130 may be a device that is controlled or owned by a second user who is different from a first user of first device 120.

In some other embodiments, server 140 may receive, from first device 120, a request to sell the media content from the user account authenticated on first device 120 to the user account authenticated on second device 130, after the first user sub-rights to the media content were issued to the user account authenticated on first device 120. Thus, remaining user sub-rights to the media content may also be transferred from first device 120 to second device 130, along with the media content.

For example, second device 130 may be a device that is controlled or owned by a second user who is different from a first user of first device 120. Thus, server 140 may issue, to the user account authenticated on second device 130, the remaining user sub-rights from which the first user sub-rights are removed. According to the above example, first device 120 may play or reproduce the media content only up to, e.g., 25 times based on the first user sub-rights, and second device 130 may play the media content up to, e.g., 75 times based on the remaining user sub-rights.

Therefore, FIG. 1 shows an example system 10 in which management of user rights to media content may be implemented, in accordance with various embodiments described herein.

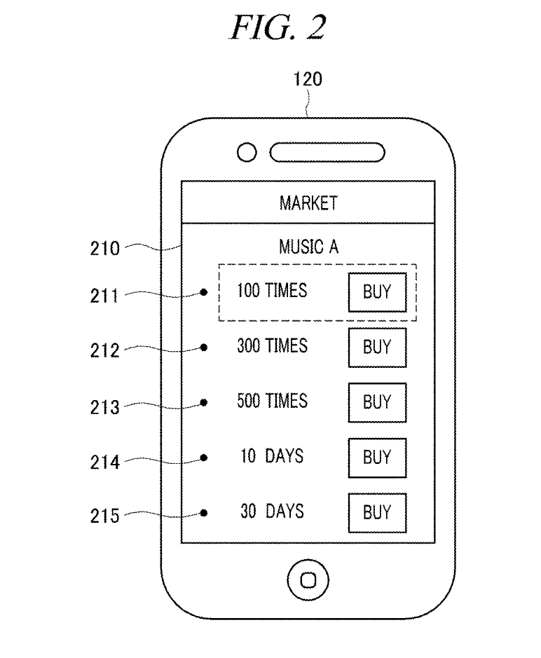

FIG. 2 shows an illustrative example device by which at least portions of management of user rights to media content may be implemented, in accordance with various embodiments described herein. As depicted in FIG. 2, for example, first device 120 may be configured to display a list 210 that includes a menu of purchase options for full user rights to media content (e.g., music A) on a display screen that may be part of, or communicatively coupled to, first device 120. For example, first full user rights option 211 for the purchase of rights to media content may include a full allocation that allows the media content to be played up to, e.g., 100 times. Second full user rights option 212 for the purchase of rights to media content may include a full allocation that allows the media content to be played up to e.g., 300 times. Third full user rights option 213 for the purchase of rights to media content may include a full allocation that allows the media content to be played up to e.g., 500 times. Fourth full user rights option 214 for the purchase of rights to media content may include a full allocated period in which the media content to be played for e.g., 10 days. Fifth full user rights option 215 for the purchase of rights to media content may include a full allocated period in which the media content to be played for e.g., 30 days.

Further, first device 120 may receive user input to request to purchase full user rights to the media content from the purchase options displayed on list 210. For example, first device 120 may receive a user input to select first full user rights option 211, which include the full allocation to play the media content up to, e.g., 100 times, to be purchased from displayed list 210. First device 120 may transmit, to server 140, a request to issue the selected first full user rights to the media content, based on the received user input.

Thus, FIG. 2 shows an illustrative example device by which at least portions of management of user rights to media content may be implemented, in accordance with various embodiments described herein.

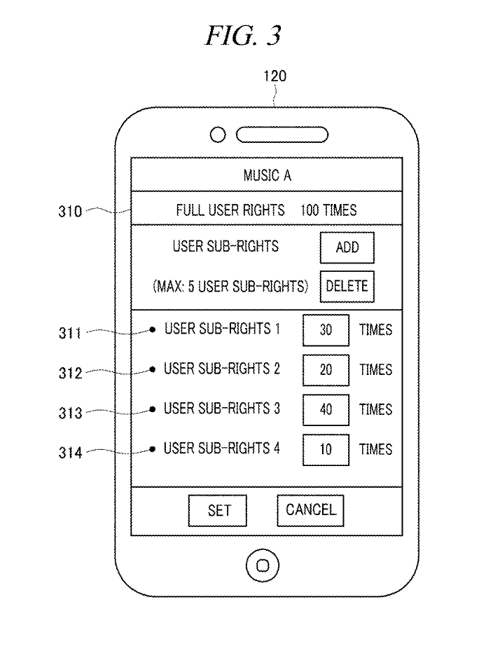

FIG. 3 shows another illustrative example device by which at least portions of management of user rights to media content may be implemented, in accordance with various embodiments described herein. As depicted in FIG. 3, for example, first device 120 may be configured to display an interface 310 that may include a menu of terms under which server 140 may divide full user rights into multiple user sub-rights to media content, from which a user may choose. Thus, a number of user sub-rights into which the full user rights to be divided and authorized times or periods for plays of the media content using respective user sub-rights may be determined based on the user selection from interface 310. Server 140 may transmit interface 310 to first device 120, when server 140 receives a request to issue the full user rights to the media content from first device 120.

First device 120 may receive, via interface 310, a user input to determine and/or change a number of user sub-rights. Further, first device 120 may receive, via interface 310, a user input to determine and/or change a sub allocation of plays of the media content or a sub allocated period of time in which the media content may be authorized to be played, included in respective user sub-rights.

For example, as depicted in FIG. 3, first device 120 may receive a user input to determine a number of user sub-rights to be, e.g., four (e.g., first user sub-rights 311, second user sub-rights 312, third user sub-rights 313 and fourth user sub-rights 314). Further, first device 120 may receive a user input to determine a first sub allocation of a number of authorized plays for the media content that is associated with first user sub-rights 311 to be, e.g., 30. First device 120 may receive a user input to determine a second sub allocation of a number of authorized plays for the media content that is associated with second user sub-rights 312 to be, e.g., 20. First device 120 may receive a user input to determine a third sub allocation of a number of authorized plays for the media content that is associated with third user sub-rights 313 to be, e.g., 40. Further, first device 120 may receive a user input to determine a fourth sub allocation of a number of authorized plays for the media content that is associated with fourth user sub-rights 314 to be, e.g., 10.

First device 120 may further transmit, to server 140, the term or terms that include the number of multiple user sub-rights into which the full user rights may be divided, and sub allocations of authorized plays for the media content or sub allocated periods of authorized plays for media content, which may be associated with each user sub-rights. Server 140 may be configured to then divide the full user rights to the media content into the determined number of multiple user sub-rights that have the determined sub allocations of plays or sub allocated periods of plays, based on the transmitted term.

Thus, FIG. 3 shows another illustrative example device by which at least portions of management of user rights to media content may be implemented, in accordance with various embodiments described herein.

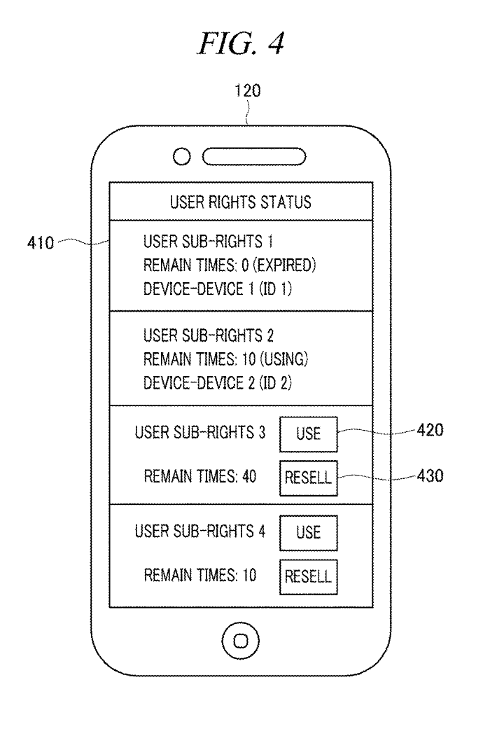

FIG. 4 shows another illustrative example device by which at least portions of management of user rights to media content may be implemented, in accordance with various embodiments described herein. For example, first device 120 may display a user rights status 410 that shows issued user sub-rights to media content and remaining user sub-rights to the media content. Thus, a user may know a history or a present status regarding the issuance of user sub-rights to the media content, which may be associated with user accounts that are authenticated on his/her own devices. Further, via displayed user rights status 410, a user may manage remaining user sub-rights to the media content to be used on his/her own device or to be transferred to another device.

As depicted in FIG. 4, for example, user rights status 410 may indicate that first user sub-rights to the media content were issued to a user account authenticated on first device 120 and that the issued first user sub-rights expired. Further, user rights status 410 may indicate that second user sub-rights to the media content were issued to a user account authenticated on second device 130 and that a sub allocation of plays of the media content, which is associated with the second user sub-rights, includes ten authorized plays of the media content. Further, user rights status 410 may indicate that third user sub-rights to the media content, which have a sub allocation to play the media content up to, e.g., 40 times, are not yet issued and that it is possible to use the third user sub-rights to the media content or to resell the third user sub-rights to the media content to another user account for use on another device on which the other user account may be authenticated. Further, user rights status 410 may indicate that fourth user sub-rights to the media content, which have a sub allocation to play the media content up to, e.g., 10 times, are not yet issued and that it is possible to use the fourth user sub-rights to the media content or to resell the fourth user sub-rights to the media content to another user account for use on another device on which the other user account may be authenticated.

Further, for example, first device 120 may receive a user input to an icon 420 that may be configured to receive a request to issue the third user sub-rights to the media content when a user of first device 120 wants the media content to be played or reproduced on first device 120 using the third user sub-rights to the media content. First device 120 may transmit, to server 140, the request to issue the third user sub-rights to the media content, when first device 120 receives the user input to icon 420. Server 140 may then issue, to the user account authenticated on first device 120, the third user sub-rights in response to the request.

Further, for example, first device 120 may receive a user input to an icon 430 that may be configured to receive a request to resell the third user sub-rights to the media content to another device (e.g., second device 130) when a user of first device 120 wants the media content and remaining user sub-rights (e.g., the third user sub-rights) to be transferred from first device 120 to another device. First device 120 may transmit, to server 140, the request to resell the third user sub-rights to the media content to the other device, when first device 120 receives the user input to icon 430. Server 140 may then issue, to a user account authenticated on the other device, the third user sub-rights in response to the request.

Thus, FIG. 4 shows another illustrative example device by which at least portions of management of user rights to media content may be implemented, in accordance with various embodiments described herein.

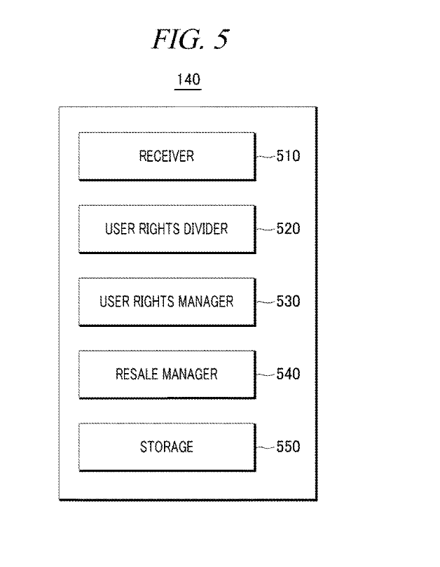

FIG. 5 shows an example server by which at least portions of management of user rights to media content may be implemented, in accordance with various embodiments described herein. As depicted in FIG. 5, server 140 may include a receiver 510, a user rights divider 520, a user rights manager 530, a resale manager 540 and a storage 550. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of receiver 510, user rights divider 520, user rights manager 530, resale manager 540 and storage 550 may be included in an instance of an application hosted on server 140.

Receiver 510 may be configured to receive, from first device 120, a request of a user of first device 120 for user rights to media content to be issued to a user account authenticated on first device 120. The user rights may be needed for first device 120 to legally play or reproduce the media content, and thus, a user of first device 120 may request or order for the user rights to the media content. For example, but not as a limitation, user rights to the media content may refer to full or limited authorization to access, use, play, reproduce, listen, read and/or download the media content. Further, non-limiting examples of the media content may refer to at least one of eBooks, video files, audio files, e-coupons or e-gift cards.

Further, receiver 510 may receive, from first device 120, one or more terms for user rights division under which user rights divider 520 is to divide full user rights to the media content into multiple user sub-rights to the media content. The full user rights to the media content may include at least one of a full allocation of plays of the media content or a full allocated period of time in which to play the media content. The term for user rights division may refer to a condition or an option under which user rights divider 520 may divide the full user rights, which may include a full allocation of plays of the media content or full allocated period of time in which to play the media content, into multiple user sub-rights that may include multiple various sub allocations or multiple various sub allocated periods. Further, the term may include a number of multiple user sub-rights into which the full user rights to be divided.

Further, receiver 510 may receive, from first device 120, a user input to select user sub-rights to be issued from among multiple user sub-rights to the media content. For example, receiver 510 may receive, from first device 120, a user input to select first user sub-rights from a user rights list that shows the multiple user sub-rights to the media content. Further, when the issued first user sub-rights to the media content expire, receiver 510 may be configured to receive, from first device 120, a user input to select a second user sub-rights to be issued from the user rights list that shows remaining user sub-rights from which the issued first user sub-rights are removed.

User rights divider 520 may be configured to divide the full user rights to the media content into multiple user sub-rights to the media content. User rights divider 520 may be configured to divide the full user rights into the multiple user sub-rights, based on the received terms that may include a number of multiple user sub-rights and sub allocations of a number of authorized plays or sub allocated authorized periods of plays corresponding to each user sub-rights.

User rights manager 530 may be configured to issue, to a user account authenticated on first device 120, one or more user sub-rights to the media content from among the multiple user sub-rights. In some embodiments, server 140 may issue, to the user account authenticated on first device 120, first user sub-rights to the media content from among the multiple user sub-rights. Further, user rights manager 530 may revoke the issued user sub-rights to the media content from the multiple user sub-rights for managing the remaining user sub-rights to the media content. In some embodiments, user rights manager 530 may revoke the issued first user sub-rights to the media content from the multiple user sub-rights.

Further, user rights manager 530 may issue, to the user account authenticated on first device 120, additional one or more user sub-rights to the media content from among the multiple user sub-rights, when previously issued user sub-rights expire. For example, user rights manager 530 may transmit, to first device 120, a user rights list that show remaining user sub-rights to the media content, if the first user sub-rights to the media content expire. User rights manager 530 may issue, to the user account authenticated on first device 120, second user sub-rights from among the remaining user sub-rights, based on a user input to select the second user sub-rights from the user rights list.

In some embodiments, user rights manager 530 may issue respective user sub-rights to different user accounts of devices for playing the media content on two or more devices based on the issued respective user sub-rights. For example, user rights manager 530 may issue, to the user account authenticated on first device 120, first user sub-rights to the media content from among the multiple user sub-rights. Further, user rights manager 530 may transmit, to first device 120, a user rights list that shows remaining user sub-rights to the media content. User rights manager 530 may issue, to a user account authenticated on second device 130, second user sub-rights from among the remaining user sub-rights, based on a user input to request to issue the second user sub-rights to the user account authenticated on second device 130 from the user rights list. For example, second device 130 may be a device which is controlled or owned by the same user of first device 120 and to which a unique identifier, a serial number or a phone number that is different from that of first device 120 is assigned. Thus, the same media content may be played on multiple devices (i.e., first device 120 and second device 130), based on respective user sub-rights to the media content.

In some embodiments, user rights manager 530 may issue, to the user account authenticated on first device 120, first user sub-rights to the media content from among the multiple user sub-rights. Further, user rights manager 530 may issue, to the user account authenticated on second device 130, second user sub-rights to the media content from among the multiple user sub-rights, based on a request to sell the second user sub-rights to the media content to the user account authenticated on second device 130. For example, second device 130 may be a device that is controlled or owned by a second user who is different from a first user of first device 120. Thus, the same media content may be played on multiple devices (i.e., first device 120 and second device 130), based on respective user sub-rights (e.g., first user sub-rights and second user sub-rights) to the media content

In some embodiments, user rights manager 530 may issue, to the user account authenticated on first device 120, first user sub-rights to the media content from among the multiple user sub-rights. Further, user rights manager 530 may issue, to the user account authenticated on second device 130, remaining user sub-rights from which the first user sub-rights are removed, based on a request to sell the media content from the user account authenticated on first device 120 to the user account authenticated on second device 130. For example, second device 130 may be a device that is controlled or owned by a second user who is different from a first user of first device 120. Thus, the remaining user sub-rights to the media content may be transferred from first device 120 to second device 130, along with the media content.

Further, in some embodiments, user rights manager 530 may transmit, to at least one of first device 120 and second device 130, a decryption key that may be used to decrypt media content that was encrypted by service provider 150, along with the one or more user sub-rights to the media content.

Resale manager 540 may receive, from first device 120, the request to sell the second user sub-rights to the media content from among the multiple user sub-rights to the user account authenticated on second device 130.

Storage 550 may be configured to store a user rights history regarding issued user sub-rights and remaining user sub-rights, from which the issued user sub-rights are removed, in association with a user account authenticated on a device (e.g., first device 120 and/or second device 130) to which the user sub-rights are issued. For example, storage 550 may store information that may indicate that first user sub-rights were issued to the user account authenticated on first device 120 and that second user sub-rights were issued to the user account authenticated on second device 130 and that remaining user sub-rights, from which the first user sub-rights and the second user sub-rights are removed, are not yet transmitted.

Thus, FIG. 5 shows an example server by which at least portions of management of user rights to media content may be implemented, in accordance with various embodiments described herein.

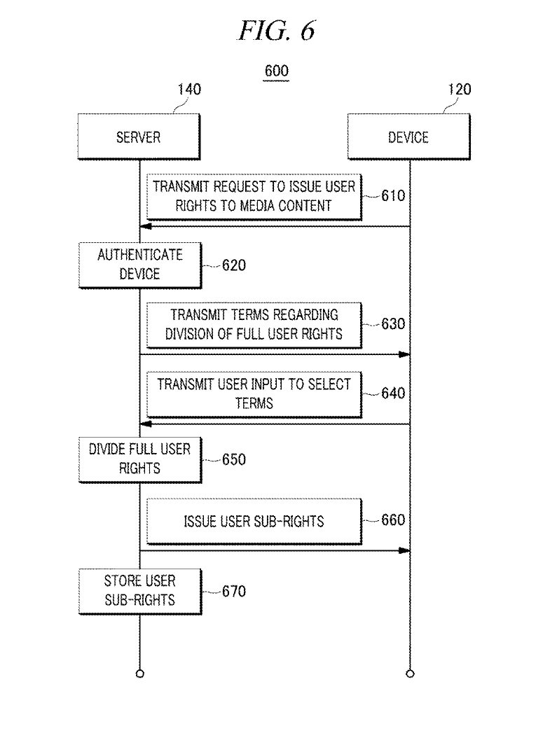

FIG. 6 shows an example processing flow 600 of operations by which at least portions of management of user rights to media content may be implemented, in accordance with various embodiments described herein. The operations of processing flow 600 may be implemented in system 10 including first device 120, second device 130, server 140 and content provider 150, as illustrated in FIG. 1. Processing flow 600 may include one or more operations, actions, or functions as illustrated by one or more blocks 610, 620, 630, 640, 650, 660 and/or 670. Although illustrated as discrete blocks, various blocks may be divided into additional blocks, combined into fewer blocks, or eliminated, depending on the desired implementation. Processing may begin at block 610.

Block 610 (Transmit Request to Issue User Rights to Media Content) may refer to a device (e.g., first device 120 or second device 130) transmitting a request to issue user rights to media content. The user rights may be needed for the device to legally play or reproduce the received media content, and thus, a user of the device may request or order for the user rights to the media content. Non-limiting examples of the media content may refer to at least one of eBooks, video files, audio files, e-coupons or e-gift cards. In some embodiments, the media content may be encrypted content that has been encrypted by content provider 150 with an encryption key. Further, for example, but not as a limitation, user rights to the media content may refer to full or limited authorization to access, use, play, reproduce, listen, read and/or download the media content from content provider 150. Processing may proceed from block 610 to block 620.

Block 620 (Authenticate Device) may refer to server 140 authenticating the device from which the request to issue the user rights was received, based on authentication information of the device. For example, but not as a limitation, the authentication information of the device may include a unique identifier of the device, a serial number, or a phone number assigned to the device. Processing may proceed from block 620 to block 630.

Block 630 (Transmit Terms Regarding Division of Full User Rights) may refer to server 140 transmitting, to the device, multiple terms for user rights division under which server 140 may divide full user rights to the media content into multiple user sub-rights. The full user rights to the media content may include at least one of a full allocation of plays of the media content or a full allocated period of time in which to play the media content. Each of the multiple terms may refer to a condition or an option under which server 140 may divide full user rights, which may include a full allocation of plays of the media content or full allocated period of time in which to play the media content, into multiple user sub-rights that may include multiple various sub allocations or multiple various sub allocated periods. Processing may proceed from block 630 to block 640.

Block 640 (Transmit User Input to Select Terms) may refer to the device transmitting, to server 140, one or more terms from among the multiple terms transmitted at block 630. Further, The term may include a number of multiple user sub-rights into which the full user rights to be divided, and sub allocations of plays of the media content or sub allocated periods of plays of the media content which is associated with each user sub-rights. Processing may proceed from block 640 to block 650.

Block 650 (Divide Full User Rights) may refer to server 140 dividing the full user rights to the media content into the multiple user sub-rights to the media content, based on the one or more terms received at block 640. For example, but not as a limitation, at block 650, server 140 may divide the full user rights that allow the media content to be played up to e.g., total 100 times into four user sub-rights, each of which has a sub allocation that allow the media content to be played up to e.g., 25 times. Processing may proceed from block 650 to block 660.

Block 660 (Issue User Sub-Rights) may refer to server 140 issuing, to a user account authenticated on the device, one or more user sub-rights to the media content from among the multiple user sub-rights. In some embodiments, at block 660, server 140 may issue, to the user account authenticated on the device, first user sub-rights to the media content from among the multiple user sub-rights. Further, in some embodiments, server 140 may transmit, to the device, a decryption key that may be used to decrypt the encrypted media content, along with the one or more user sub-rights to the media content. Processing may proceed from block 660 to block 670.

Block 670 (Store User Sub-Rights) may refer to server 140 storing information regarding remaining user sub-rights from which the user sub-rights issued at block 660 are removed. For example, the information regarding the remaining user sub-rights may include a number of the remaining user sub-rights, remaining number of authorized plays of the media content, and/or remaining authorized time in which to play the media content. At block 670, server 140 may revoke the issued user sub-rights to the media content from the multiple user sub-rights. Server 140 may then manage the remaining user sub-rights. For example, server 140 may revoke the issued first user sub-rights to the media content from the multiple user sub-rights.

Thus, FIG. 6 shows an example processing flow 600 of operations by which at least portions of management of user rights to media content may be implemented, in accordance with various embodiments described herein.

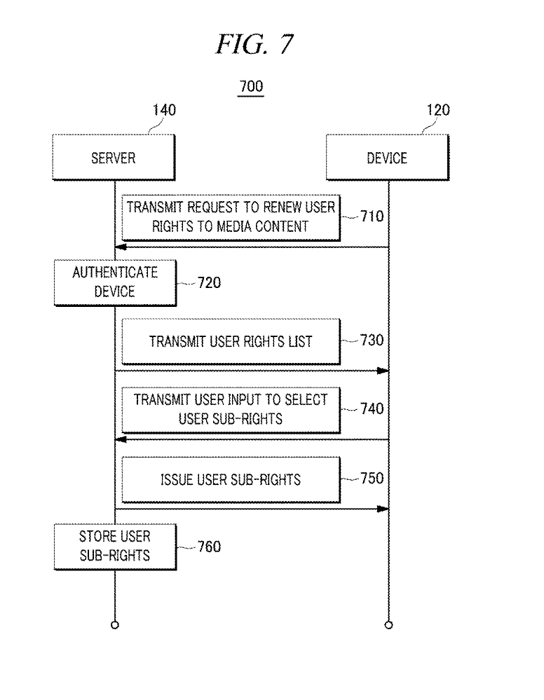

FIG. 7 shows another example processing flow 700 of operations by which at least portions of management of user rights to media content may be implemented, in accordance with various embodiments described herein. The operations of processing flow 700 may be implemented in system 10 including first device 120, second device 130, server 140 and content provider 150, as illustrated in FIG. 1. Processing flow 700 may include one or more operations, actions, or functions as illustrated by one or more blocks 710, 720, 730, 740, 750 and/or 760. Although illustrated as discrete blocks, various blocks may be divided into additional blocks, combined into fewer blocks, or eliminated, depending on the desired implementation. Processing may begin at block 710.

Block 710 (Transmit Request to Renew User Rights to Media Content) may refer to a device (e.g., first device 120 or second device 130) transmitting, to server 140, a request to renew user rights to the media content. The device may transmit, to server 140, the request for renewal of the user rights, when first user sub-rights that were already issued to a user account authenticated on the device expire. Processing may proceed from block 710 to block 720.

Block 720 (Authenticate Device) may refer to server 140 authenticating the device from which the request to renew the user rights to the media content was received, based on authentication information of the device. For example, but not as a limitation, the authentication information of the device may include a unique identifier of the device, a serial number, or a phone number assigned to the device. Processing may proceed from block 720 to block 730.

Block 730 (Transmit User Rights List) may refer to server 140 transmitting, to the device, a user rights list that shows remaining user sub-rights from which the first user sub-rights are removed. Processing may proceed from block 730 to block 740.

Block 740 (Transmit User Input to Select User Sub-Rights) may refer to the device transmitting, to server 140, a user input to select second user sub-rights to be issued next from the user rights list which is transmitted at block 730. At block 740, the device may display the user rights list on a display that may be part of, or communicatively coupled to, the device. Further, the device may receive a user input to select the second user sub-rights from the user rights list and may transmit the received user input to server 140. Processing may proceed from block 740 to block 750.

Block 750 (Issue User Sub-Rights) may refer to server 140 issuing, to the user account authenticated on the device, the second user sub-rights from among the remaining user sub-rights, based on the user input received at block 740. Processing may proceed from block 750 to block 760.

Block 760 (Store User Sub-Rights) may refer to server 140 storing information regarding remaining user sub-rights from which the first user sub-rights and the second user sub-rights are removed. For example, the information regarding the remaining user sub-rights may include a number of the remaining user sub-rights, remaining authorized plays of the media content, and/or remaining authorized time in which to play the media content. At block 760, server 140 may revoke the second user sub-rights to the media content from the remaining user sub-rights from which the first user sub-rights had been removed. Server 140 may then manage the remaining user sub-rights

Thus, FIG. 7 shows another example processing flow 700 of operations by which at least portions of a management of user rights to media content may be implemented, in accordance with various embodiments described herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

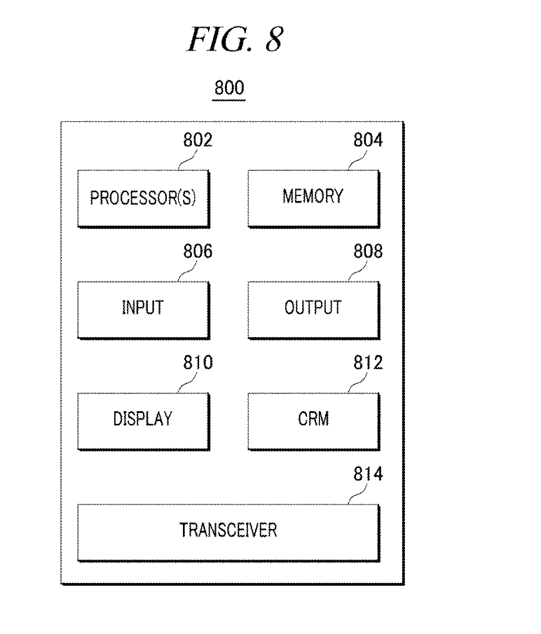

FIG. 8 shows an illustrative computing embodiment, in which any of the processes and sub-processes of a management of user rights to media content may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 800 may typically include, at least, one or more processors 802, a system memory 804, one or more input components 806, one or more output components 808, a display component 810, a computer-readable medium 812, and a transceiver 814.

Processor 802 may refer to, e.g., a microprocessor, a microcontroller, a digital signal processor, or any combination thereof.

Memory 804 may refer to, e.g., a volatile memory, non-volatile memory, or any combination thereof. Memory 804 may store, therein, an operating system, an application, and/or program data. That is, memory 804 may store executable instructions to implement any of the functions or operations described above and, therefore, memory 804 may be regarded as a computer-readable medium.

Input component 806 may refer to a built-in or communicatively coupled keyboard, touch screen, or telecommunication device. Alternatively, input component 806 may include a microphone that is configured, in cooperation with a voice-recognition program that may be stored in memory 804, to receive voice commands from a user of computing device 800. Further, input component 806, if not built-in to computing device 800, may be communicatively coupled thereto via short-range communication protocols including, but not limitation, radio frequency or Bluetooth.

Output component 808 may refer to a component or module, built-in or removable from computing device 800, that is configured to output commands and data to an external device.

Display component 810 may refer to, e.g., a solid state display that may have touch input capabilities. That is, display component 810 may include capabilities that may be shared with or replace those of input component 806.

Computer-readable medium 812 may refer to a separable machine readable medium that is configured to store one or more programs that embody any of the functions or operations described above. That is, computer-readable medium 812, which may be received into or otherwise connected to a drive component of computing device 800, may store executable instructions to implement any of the functions or operations described above. These instructions may be complimentary or otherwise independent of those stored by memory 804.

Transceiver 814 may refer to a network communication link for computing device 800, configured as a wired network or direct-wired connection. Alternatively, transceiver 814 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A server, comprising:
a receiver configured to receive, from a first device, a request to issue user rights to media content;
a user rights divider configured to divide full user rights to the media content into a plurality of user sub-rights to the media content; and
a user rights manager configured to issue one or more of the plurality of user sub-rights to the media content to a user account authenticated on the first device.

2. The server of claim 1, wherein the full user rights to the media content includes at least one of a full allocation of plays of the media content or a full allocated period of time in which to play the media content.

3. The server of claim 1, wherein the receiver is further configured to receive, from the first device, one or more terms under which the user rights divider is to divide the full user rights to the media content, and
wherein the user rights divider is configured to divide the full user rights to the media content into the plurality of user sub-rights, based on the received one or more terms.

4. The server of claim 1, wherein the user rights manager is further configured to:
issue, to the user account authenticated on the first device, a first user sub-right from among the plurality of user sub-rights, and
issue, to a user account authenticated on a second device, a second user sub-right from among the plurality of user sub-rights.

5. The server of claim 4, further comprising:
a storage configured to store a user rights history regarding the issued first user sub-right, the issued second user sub-right and the remaining user sub-rights, from which the first user sub-right and the second user sub-right are removed, in association with the user account authenticated on the first device and the user account authenticated on the second device.

6. The server of claim 1, further comprising:
a resale manager configured to receive a request to sell the media content from the user account authenticated on the first device to a user account authenticated on a second device;
wherein the user rights manager is further configured to issue, to the user account authenticated on the second device, the remaining user sub-rights from which the one or more of user sub-rights are removed.

7. The server of claim 1, wherein the user rights manager is further configured to:
issue, to the user account authenticated on the first device, a first user sub-right from among the plurality of user sub-rights, and
revoke the first user sub-right from the plurality of user sub-rights.

8. The server of claim 1, wherein the user rights manager is further configured to:
issue, to the user account authenticated on the first device, a first user sub-right from among the plurality of user sub-rights, and
issue, to the user account authenticated on the first device, a second user sub-right from among the plurality of user sub-rights, when the first user sub-right expires.

9. The server of claim 8, wherein the user rights manager is further configured to transmit, to the first device, a user rights list that shows the remaining user sub-rights from which the first user sub-right is removed, and
wherein the receiver is further configured to receive, from the first device, a user input to select the second user sub-right from the user rights list.

10. The server of claim 1, wherein the user rights manager is further configured to issue, to the user account authenticated on the first device, a first user sub-right from among the plurality of user sub-rights,
wherein the server further comprises:
a resale manager configured to receive, from the first device, a request to sell a second user sub-right from among the plurality of user sub-rights to a user account authenticated on a second device,
wherein the user rights manager is further configured to issue, to the user account authenticated on the second device, the second user sub-right.

11. A system, comprising:
a device configured to transmit a request to issue user rights to media content; and
a server configured to:
divide full user rights to the media content into a plurality of user sub-rights to the media content, and
issue one or more of the plurality of user sub-rights to the media content to a user account authenticated on the device.

12. The system of claim 11, wherein the full user rights to the media content includes at least one of a full allocation of plays of the media content or a full allocated period of time in which to play the media content.

13. The system of claim 11, wherein the server is further configured to transmit, to the device, a plurality of terms under which the server is to divide the full user rights to the media content,
wherein the device is further configured to transmit, to the server, a user input to select one or more of the plurality of terms, and
wherein the server is further configured to divide the full user rights to the media content into the plurality of user sub-rights, based on the selected one or more terms.

14. The system of claim 11, wherein the server is further configured to transmit, to the device, a user rights list that includes the plurality of user sub-rights,
wherein the server is further configured to receive, from the device, a user input to select a first user sub-right from the user rights list,
wherein the server is further configured to issue, to the user account authenticated on the device, the first user sub-right from among the plurality of user sub-rights, based on the received user input.

15. The system of claim 11, wherein the server is further configured to issue, to the user account authenticated on the device, a first user sub-right from among the plurality of user sub-rights,
wherein the server is further configured to revoke the first user sub-right from the plurality of user sub-rights.

16. The system of claim 11, wherein the server is further configured to issue, to the user account authenticated on the device, a first user sub-right from among the plurality of user sub-rights,
wherein the device is further configured to transmit, to the server, a request to issue a second user sub-right from among the plurality of user sub-rights, when the first user sub-right expires,
wherein the server is further configured to issue the second user sub-right to the user account authenticated on the device.

17. A method performed under control of a server, comprising:
receiving, from a device, a request to issue user rights to media content;
dividing full user rights to the media content into a plurality of user sub-rights to the media content; and
issuing one or more of the plurality of user sub-rights to the media content to a user account authenticated on the device.

18. The method of claim 17, wherein the full user rights to the media content includes at least one of a full allocation of plays of the media content or a full allocated period of time in which to play the media content.

19. The method of claim 17, further comprising:
transmitting, to the device, a plurality of terms under which the server is to divide the full user rights to the media content; and
receiving, from the device, a user input to select one of the plurality of terms,
wherein the dividing is based on the selected term.

20. The method of claim 19, wherein the issuing includes issuing, to the user account authenticated on the device, a first user sub-right from among the plurality of user sub-rights,
wherein the method further comprises:
issuing, to the user account authenticated on the device, a second user sub-right from among the plurality of user sub-rights, when the first user sub-right expires.
